(19) United States
(12) Patent Application Publication
(10) Pub. No.: US 2008/0141823 A1
(43) Pub. Date: Jun. 19, 2008

(54) Gearbox Drive Unit Comprising a Regulating Element

(76) Inventors: Hans-Juergen Oberle, Rastatt (DE); Franz Schwendemann, Ottersweier (DE); Andreas Lienig, Buehl (DE)

Correspondence Address: Striker, Striker & Stenby, 103 East Neck Road, Huntington, NY, 11743, US

(21) Appl. No.: 10/588,357

(22) PCT Filed: Aug. 16, 2005
(86) PCT No.: PCT/EP05/54026

§ 371 Date: Aug. 3, 2006

(30) Foreign Application Priority Data
Sep. 23, 2004 (DE) 10 2004 046 094.9

(51) Int. Cl. F16H 57/02

(52) U.S. Cl. 74/606 R

(57) ABSTRACT

The invention relates to a gearbox drive unit (10), especially for displacing a movable part in a motor vehicle, and to a method for producing one such gearbox drive unit. The inventive gearbox drive unit includes a rotary body (14) which is rotatably mounted in a housing (12) and bears axially—via at least one end face (42) thereof—against an adjusting element (50) which is fixed to the housing (12). The adjusting element (50) can be slid axially into the housing (12) for installation, and can be locked axially by rotating it relative to the housing (12). The adjusting element (50) includes a radial bearing surface (56, 54) in which the rotary body (14) is radially supported.

### RELATED ART

The present invention relates to a gearbox drive unit with an adjusting element, and a method for manufacturing a gearbox drive unit of this type, according to the preamble of the independent claims.

A drive unit was made known in DE 31 50 572 A1, with which the manufacturing tolerances between the armature shaft and the housing that supports it are eliminated using an adjusting screw. To this end, the housing includes an internal thread, in which the adjusting screw engages via an external thread. To offset the axial play of the armature shaft, the adjusting screw is screwed, with a stop face, against the end face of the rotor shaft.

With a device of this type, manufacturing a thread in the housing and in the adjusting screw is relatively complex. In addition, the contact force of the screw against the end face of the rotor shaft cannot be specified exactly, since undefined friction forces occur during screwing into the thread. In addition, an adjusting screw of this type is not suited for centering the adjusting element such that the shaft can be accommodated in the adjusting element in a radially supported manner.

### ADVANTAGES OF THE INVENTION

The inventive device and the method for manufacturing a device of this type with the features of the independent claims have the advantage that a defined contact force against the end face of the rotary body can be specified via the axial insertion of the adjusting element into the housing. When the adjusting element is inserted, it centers itself relative to the housing such that the radial bearing surface of the adjusting element accommodates the rotary body with an exact fit, to support it radially in the adjusting element. As a result, fitting tolerances of the rotary body can be compensated for, since the adjusting element is not secured axially or radially until it is slid axially onto the rotary body and rotated in the housing.

Advantageous refinements of the device and the manufacturing method described in the independent claims are made possible by the measures listed in the subclaims. When the radial bearing surface of the adjusting element is designed as a circumferential outer cylinder surface of a cylindrical recess, the rotary body is supported radially and evenly around its entire circumference. The fact that the adjusting element is centered in the housing ensures a very even concentricity of the rotary body. The cylindrical recess of the adjusting element can be designed as a blind hole or a through-opening, depending on the design of the rotary body.

To fix the adjusting element in position axially in the housing, an axial retaining region is formed on a certain axial section of the adjusting element, the axial retaining region locking the adjusting element axially relative to the housing when the adjusting element is rotated. To this end, the retaining region has different outer diameters around its circumference, so that, when the retaining region is rotated, the circumferential surfaces with the larger diameter interact in a non-sliding manner with the corresponding opposite surface of the housing.

Via the design of an outer profile, e.g., as a knurl or circumferential grooves, the friction force between the adjusting element and the inner shape of the housing wall can be increased, by way of which the adjusting element is reliably secured against axial displacement or rotation.

To support high axial operating forces, it is advantageous for the outer profile to form a form-fit connection with the housing after it is rotated relative to the housing. It is particularly favorable when the outer profile includes radial projections that penetrate the inner wall of the housing in a self-cutting manner.

To create a reliable form-fit connection, the retaining region includes sections with a larger outer diameter that transition into areas with a smaller diameter. As a result, the circumference of the retaining region is designed with an undulating shape, it being possible to insert this undulating circumference of the retaining region into a corresponding undulating inner surface of the housing. When these two undulating surfaces are rotated relative to each other, only a relatively small amount of torque is required to press the regions into each other in a form-fit manner with overlapping diameters.

When the adjusting element includes a guide region located, e.g., axially adjacent to the retaining region, the guide region being guided in an inner guide surface of the housing, a very exact centering of the adjusting element and, therefore, an exact radial support of the rotary body can be attained. It is particularly favorable when the guide region has a circular diameter with a smooth surface.

The inventive embodiment of the adjusting element is particularly suited for use in a tubular gearbox housing, e.g., a spindle drive, the adjusting element axially and radially supporting the rotary body, which is designed as a worm gear. The worm gear can be located at the end of a spindle, or it can be penetrated by a spindle that passes through it.

To facilitate installation of the adjusting element, it includes a driving element—a recess, in particular—that interacts with the installation tool in a form-fit manner to rotate the adjusting element in the inner shape of the housing by a fraction of a revolution.

Using the inventive manufacturing method, a gearbox drive unit—a spindle drive, in particular—can be manufactured very cost-effectively, since no additional parts are required to fix the adjusting element in place. The adjusting element simultaneously performs the axial and radial supporting functions, and it provides support against axial operating forces. Due to the axial contact force, which is adjustable in a defined manner, a reliable compensation of axial play can be attained over the entire service life of the drive unit.

### DRAWING

Various exemplary embodiments of a device according to the present invention are presented in the drawing and are described in greater detail in the description below.

FIG. 1 shows a cross section through an inventive gearbox drive unit,

FIG. 2 shows a side view of the drive unit in FIG. 1, according to 11,

FIG. 3 shows a cross section through the drive unit in FIG. 1, according to III-III, and

FIG. 4 shows a further exemplary embodiment of an inventive drive unit.

### DESCRIPTION

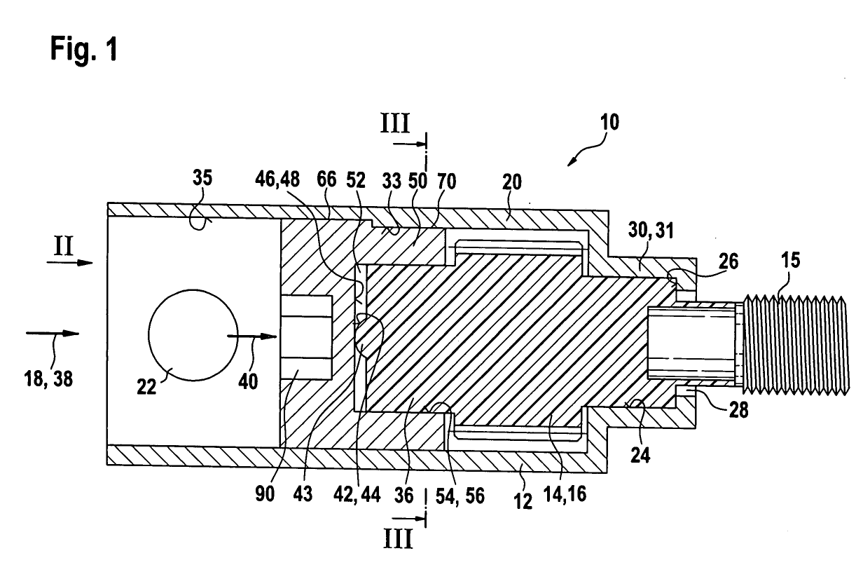

FIG. 1 shows a gearbox drive unit 10, with which a rotary body 14 is located in a housing 12. Gearbox drive unit 10 is designed, e.g., as a spindle drive 10, with which a spindle 15—as rotary body 14—with a worm gear 16 located thereon is supported in housing 12. Worm gear 16 is injection-moulded, e.g., as a plastic injection-moulded part, on the end of spindle 15, and is operatively connected with a not-shown worm shaft of a drive motor. To absorb strong axial forces 18, e.g., crash forces on a seat-adjustment drive, housing 12 is designed as a tubular metal cage 20. To secure housing 12, housing 12 includes a through-hole 22 for accommodating a bolt located on the body or seat frame. When housing 12 is securely fastened, e.g., to the seat, and when worm gear 16 is set into motion via an electric motor, spindle 15—which is non-rotatably connected with worm gear 16—rotates, spindle 15 engaging, e.g., in a counternut fastened to the body. As a result, a relative motion between the seat and the body, or between different movable parts, is produced.

Housing 12 has a first region 30, which is designed as a bearing point 31 for rotary body 14. Bearing point 31 includes a circular inner wall 24, against which rotary body 14 bears radially. Bearing point 31 also includes an axial collar 26, against which rotary body 14 bears directly, or axially via an additional thrust washer 27. During installation, after rotary body 14 has been inserted into housing 12 in axial direction 38 (from the left as shown in FIG. 1), such that spindle 15 projects through an opening 28 in housing 12 on axial collar 26, an adjusting element 50 is inserted axially into housing 12. The purpose of adjusting element 50 is to support rotary body 14 axially and radially at end 36 opposite to axial collar 26 during normal operation. To this end, adjusting element 50 is pressed in axial direction 38 with a selectable contact force 40 against an end face 42 of rotary body 14 and is subsequently secured against axial displacement via a rotation 39 by a fraction of 360°. In the exemplary embodiment according to FIG. 1, end face 42 is designed as a sphere 43 with a radius 44 that bears against an axial stop face 46 of adjusting element 50. A cylindrical recess 52 with a base face 48 is formed in adjusting element 50, cylindrical recess 52 serving as axial stop face 46 for end face 42 of rotary body 14. Cylindrical recess 52 also forms a cylindrical wall 54—as radial bearing surface 56 of adjusting element 50—against which rotary body 14 bears radially during normal operation. To radially center adjusting element 50, it has an axial section that is designed as guide region 66. In the exemplary embodiment, guide region 66 has a circular circumference 68 that is centered when inserted in axial direction 38 into a corresponding circular centering section 35 of housing 12. During normal operation, end 36 of rotary body 14 therefore bears radially against housing 12 via guide region 66 by way of cylindrical jacket 54 of adjusting element 50.

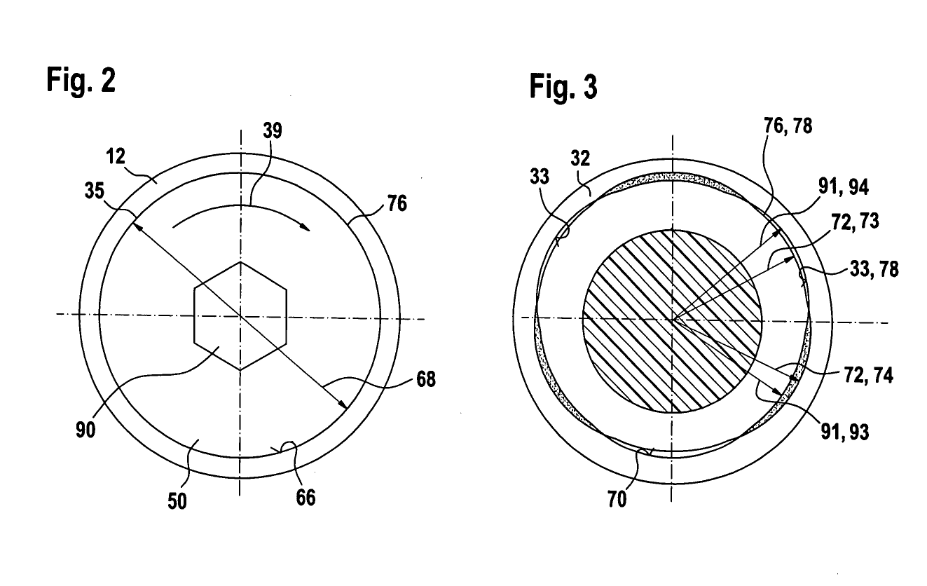

The radial guidance of adjusting element 50 is illustrated in FIG. 2 in a side view of gearbox drive unit 10 in FIG. 1 from the left. Diameter 68—which remains the same around circumference 76—of guide region 66 is guided in corresponding circular centering section 35 of housing 12. Adjusting element 50 forms a sliding fit with housing 12 that can be moved with a small amount of force.

To eliminate axial play, adjusting element 50 has a retaining region 70, by way of which adjusting element 50 is axially lockable by rotating it in housing 12. As shown in FIG. 3, which is a cross section through gearbox driving unit 10 in FIG. 1 through retaining region 70, retaining region 70 has a variable radius 72, with a minimum radius 73 and a maximum radius 74. Minimum radius 73 transitions continually into maximum radius 74 in the circumferential direction. As a result, retaining region 70 has a circumference 76 that is designed as an n-cornered polygonal outline 78. In the exemplary embodiment, n=3, so the cross section of retaining region 70 can also be viewed as a triangle with greatly rounded-off corners. When installed in axial direction 38, retaining region 70 is inserted into a corresponding locking section 32 of housing 12, locking section 32 having an inner shape 33 that corresponds to circumference 76 of retaining region 70. In FIG. 3, this inner shape 33 is also designed as a 3-cornered polygonal outline with three minimum and three maximum diameters 93, 94, respectively. To axially lock adjusting element 50, it is rotated, e.g., by 60°, during installation, so that the points with maximum radii 74 of retaining element 70 press into the regions of minimum radii 93 of inner shape 33. To increase the frictional connection between retaining region 70 and inner shape 33 of housing 12, retaining region 70 has an outer profile 80 that is designed, e.g., as knurling or thread grooves with no pitch.

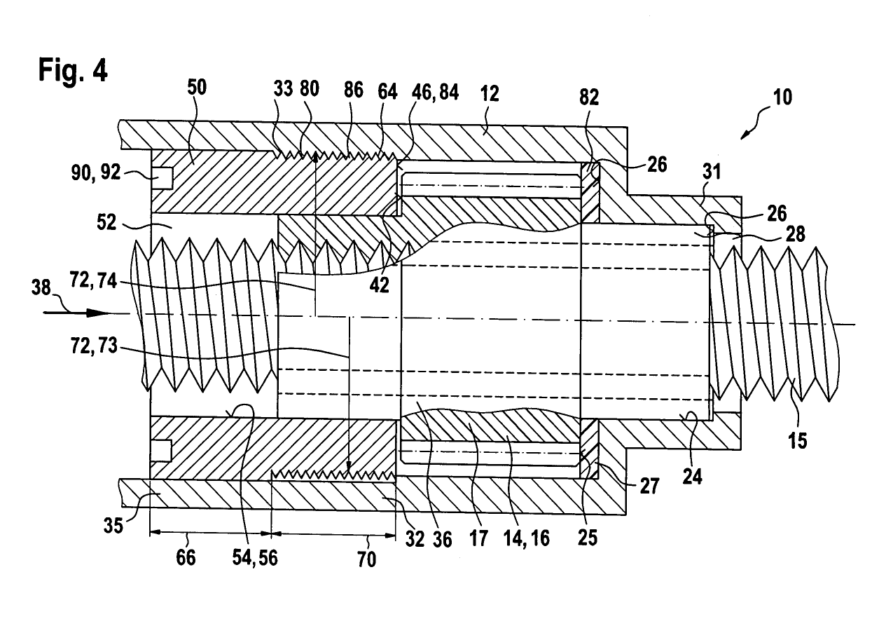

FIG. 4 shows a further exemplary embodiment, with which gearbox drive unit 10 is designed as a penetrating spindle gearbox. Rotary body 14 is designed as a worm gear 16. In this case, however, worm gear 16 is a sleeve 17 positioned such that it can rotate on spindle 15. When rotary body 14 is set into rotation via a worm gear, spindle 15 makes a linear motion in axial direction 38, by way of which movable parts can be adjusted. As in FIG. 1, rotary body 14 is supported radially in housing 12 on the side of opening 28. The axial support on housing 12 takes place here, e.g., via an elastic element 82, the purpose of which is to compensate for wear-induced material losses over the service life of gearbox 10. Via elastic element 82, rotary body 14 therefore bears, on an axial side 25, against axial collar 26. End face 42 of rotary body 14 is also designed annular in shape, however, due to sleeve shape 17. Accordingly, cylindrical recess 52 of adjusting element 50 is designed as a passage. As a result, axial stop face 46 of adjusting element 50 has the design of an annular surface 84. In this exemplary embodiment, retaining region 70 includes circumferential, self-cutting edges 64 as outer profile 80, which cut into inner shape 33 of locking section 32 of housing 12 during rotation 39. A form-fit lock that can absorb very strong axial forces is created as a result. Self-cutting edges 64 are integrally formed on several axially separated, radial segments 86, the radius 72 of which varies around the circumference. As shown in the exemplary embodiment in FIG. 1, circumference 76 can also be designed as an n-cornered polygonal outline 78, or it can have projections designed in the manner of a step function. In both cases, inner shape 33 has a corresponding inner radius 91, 93, 94 that enables axial insertion of adjusting element 50 during installation. An overlapping of inner radius 91 with outer radius 72 of retaining region is not attained until rotation 39 of adjusting element 50 is carried out to lock it in place. To apply torque to lock adjusting element 50, adjusting element 50 has a form-fit driving element 90, into which a corresponding installation tool can engage. Driving element 90 is designed as an inner polyhedron in FIG. 1, for example. With annular adjusting element 50 shown in FIG. 4, it is designed as several individual recesses 92, into which several pegs of an installation tool engage. To ensure that self-cutting edges 64 cut into inner shape 33 of housing 12 during rotation 39 by a fraction of 360°, they are made of a harder material, e.g., hardened steel, than inner shape 33 of housing 12.

In an alternative exemplary embodiment, which is not shown in greater detail, retaining region 70 and guide region 66 of adjusting element 50 and the corresponding opposite surfaces (locking section 32 and centering section 35) of housing 12 are axially transposed. During installation in axial direction 38, guide region 66 is inserted first, with a smooth surface for centering purposes, in corresponding centering section 35. Subsequently, axially adjacent retaining region 70 with variable radius 72 slides into locking section 32 for interaction. In a further variation, centering section 35 of housing 12 can be designed with the same inner shape 33 as locking section 32; the centering of adjusting element 50 in terms of radial support is then ensured in another manner.

It should be noted that, with regard for the exemplary embodiments presented in the figures and the description, many different combinations are possible. In particular, the cross section of retaining region 70 and the specific shape of outer profile 80 with the particular corresponding inner shape 33 of housing 12 can be varied in accordance with the desired application. The axial locking of adjusting element 50 can be attained using a frictional connection, a form-fit connection, or a combination thereof. It is important that adjusting element 50 be insertable axially in housing 12 for installation using only a small amount of force, and that it be subsequently secured against axial displacement via rotation 39. Application of an axial contact force 40 is thereby decoupled from the locking, by way of which contact force 40 is adjustable in a very easily defined manner. The angular division of circumference 76 can be specified via the selection of the “n” variable of n-cornered polygonal outline, so that, e.g., with n=2, 3, 4, . . . an ideal angle of rotation 39 of 90°, 60°, 45°, . . . results for locking axially into place. Instead of worm gear 16, rotary body 14 can also be designed as any other gearbox component, e.g., a spur gear or a threaded worm, or a rotor shaft of an electric motor. Gearbox drive unit 10 according to the present invention is preferably used for spindle drives to absorb strong axial forces, as is required, e.g., for seat-adjustment drives in motor vehicles.

What is claimed is:

1. A gearbox drive unit (10), especially for displacing a movable part in a motor vehicle, with a rotary body (14) which is rotatably mounted in a housing (12) and bears axially—via at least one end face (42) thereof—against an adjusting element (50) which is fixed to the housing (12),
wherein
the adjusting element (50) can be slid axially into the housing (12) for installation, and it can be locked in position axially by rotating it relative to the housing (12), the adjusting element (50) including a radial bearing surface (56, 54) in which the rotary body (14) is radially supported.

2. The gearbox drive unit (10) as recited in claim 1,
wherein
the adjusting element (50) includes a cylindrical recess (52) with a cylindrical wall (54) that is the radial bearing surface (56).

3. The gearbox drive unit (10) as recited in claim 1,
wherein
the adjusting element (50) includes a retaining region (70) with an outer radius (72, 73, 74) that is variable around its circumference (76).

4. The gearbox drive unit (10) as recited in one of the claim 1,
wherein
the retaining region (70) has an outer profile (80) that locks the adjusting element (50) in place axially when rotated in a corresponding inner shape (32, 33) of the housing (12).

5. The gearbox drive unit (10) as recited in claim 1,
wherein
the outer profile (80) forms a form-fit connection with the housing (12) when it is rotated in the inner shape (33) of the housing (12), radial projections (64, 86, 80), in particular, of the outer profile (80) digging into the inner shape (33) of the housing (12).

6. The gearbox drive unit (10) as recited in
wherein
the circumference (76) of the axial retaining region (70) is designed as an n-cornered polygonal outline (78) with a continually changing outer radius (72, 73, 74), and the retaining region (70) is axially insertable in a correspondingly shaped inner shape (33) of the housing (12) when the adjusting element (50) is installed.

7. The gearbox drive unit (10) as recited in claim 1,
wherein
the adjusting element (50) includes a guide region (66)—in particular with an outer radius (68) that is constant around the circumference (76)—for radially centering the adjusting element (50) in a corresponding centering section (35) of the housing (12).

8. The gearbox drive unit (10) as recited in
wherein
the rotary body (14) is designed as a worm gear (16) located on a gearbox spindle (15), and the housing (12) is designed as a tubular metal cage.

9. The gearbox drive unit (10) as recited in
wherein
the support element (50) includes—on the side diametrically opposed to the stop face (46)—a form-fit driving element (90), e.g, an inner polyhedron or several recesses (92), for transferring torque when support element (50) is installed.

10. A method for manufacturing a gearbox drive unit (10), in particular as recited in claim 1, comprising the following manufacturing steps:
Insert a rotary body (14) with a first axial stop in a gearbox housing (12) with a corresponding counterstop (26)
Axially insert an adjusting element (50) into the gearbox housing (12) until the adjusting element (50) bears with an axial stop face (46, 48, 84) against an end face (42) of the rotary body (14) with a specifiable contact pressure (40), the rotary body (14) bearing radially against a radial bearing surface (56, 54) of the adjusting element (12)
Axially lock the adjusting element (50) in place by rotating it by a fraction of a revolution of the adjusting element (50) inside an inner shape (33) of the gearbox housing.
